(19) United States
(12) Patent Application Publication
(10) Pub. No.: US 2018/0108150 A1
(43) Pub. Date: Apr. 19, 2018

(54) SYSTEMS AND METHODS FOR IN-FIELD STEREOCAMERA CALIBRATION

(71) Applicant: DSI Assignments, LLC, Los Angeles, CA (US)

(72) Inventor: Robert Caston Curtis, Los Angeles, CA (US)

(21) Appl. No.: 15/721,583

(22) Filed: Sep. 29, 2017

Related U.S. Application Data
(60) Provisional application No. 62/445,338, filed on Jan. 12, 2017.
(60) Provisional application No. 62/416,063, filed on Nov. 1, 2016.
(60) Provisional application No. 62/409,155, filed on Oct. 17, 2016.

(51) Int. Cl. G06T 7/80; G06T 7/593

(52) U.S. Cl. CPC G06T 7/85; H04N 13/0246; G06T 7/593

(57) ABSTRACT

Systems and methods for in-field camera calibration in a stereovision system may include using a plurality of cameras to capture an image pair, the image pair comprising images of a scene; identifying infinite points on the images of the image pair using a calibration circuit; the calibration circuit determining a disparity amount between corresponding infinite points for each camera; and the calibration circuit determining an inverse operation to reduce the determined disparity amount between the corresponding infinite points. Systems and methods may also include a calibration circuit identifying corresponding points, in which the corresponding points include a point on a first image of an image pair corresponding to a point on a second image of the image pair; determining a translational disparity amount between the corresponding points for each camera; and determining an inverse operation to reduce the determined translational disparity amount between the corresponding infinite points.

### CROSS-REFERENCE TO RELATED APPLICATIONS

This application claims the benefit of U.S. Provisional Application No. 62/445,338 filed Jan. 12, 2017, titled System and Method for In-field Stereocamera Calibration; U.S. Provisional Application No. 62/416,063 filed Nov. 1, 2016, titled In-Field Calibrated Stereocamera System and Method; and U.S. Provisional Application No. 62/409,155 filed Oct. 17, 2016, titled In-Field Calibrated Stereocamera System and Method, each of which are hereby incorporated herein by reference in their entirety.

### TECHNICAL FIELD

The disclosed technology relates generally to the surveying field, and more specifically, some embodiments relate to a new and useful autonomous, in-field surveying system calibration in the surveying field.

### DESCRIPTION OF RELATED ART

Stereoscopy has been obtained through the use of multiple cameras to image a scene. Although this practice has been in use for many decades, improvements to stereocamera imaging are still being made.

Efficient stereo vision processing typically relies on constrained epipolar geometry, which generally refers to two ideal rectilinear cameras of the same focal length and resolution, that are coplanar and that are only translated along a single axis. The axis of translation is generally either the X or Y axis and not the Z axis. All of these conditions may be difficult to satisfy with pure hardware solutions. Accordingly, some form of calibration is generally performed using image processing to correct or compensate for errors in the hardware to get close to the ideal geometry.

Generally, any difference from an ideal rectilinear frame is considered a distortion. Distortions or other imaging imperfections exist in all cameras to one level or another. These distortions can be caused by imperfections in lens manufacturing, environmental changes such as changes in temperature, inaccurate positioning of the lens relative to the image sensor, vibrations and shock, misalignment and other like imperfections or conditions. Likewise, changes in the relative placement of the two cameras can also lead to imaging imperfections.

In some cases, distortions can be introduced by design. For example, the system may be implemented with a wide-angle or “fisheye” camera that is used for multiple purposes (e.g. full scene recording, monocular vision algorithms like classifiers, stereo vision and others). Wide-angle cameras will have distortion by design and some applications can handle the distortion. Indeed, in some applications it may even be desired.

Camera calibration, then, may be used to account for imaging imperfections stereocamera systems. In a properly calibrated stereovision system, objects that are very far away (e.g., infinity) would be imaged on the same “pixel” of the image sensor of each camera (i.e., the same pixel if you overlaid the left camera and right camera frames), or close enough to the same pixel given the amount of error that can be tolerated for the given application. If these distant points on the image don't fall on the same pixel of the image sensors (i.e., precisely or close enough given the amount of acceptable error), this is an indication that there is a calibration error.

### BRIEF SUMMARY OF EMBODIMENTS

Embodiments disclosed herein provide systems and methods for stereo camera calibration that can be used to calibrate stereovision cameras in the field. As a result of in-field calibration, contrary to conventional wisdom, the cameras within a stereocamera system do not have to be rigidly mounted together, and can be installed independently. This allows the system to be more easily installed in a diverse set of applications and orientations, and allows the same stereocamera system to be used for a plurality of baselines. However, independent camera mounting can be more susceptible to changes in mechanical orientation.

Conventionally, stereopairs were rigidly mounted together because the stereopair calibration was heavily dependent on the mechanical orientation of the cameras (e.g., the relative camera positions)—if the cameras shifted relative to each other, the calibration would be lost. This shift is particularly prevalent in applications where the system is translating (e.g., in a vehicle), since vibrations (e.g., from road imperfections and acceleration cycling) and thermal changes can promote camera shifting. Losing the calibration results in inaccurate depth measurements, which renders the system inoperable for its intended purpose. While the stereopairs could theoretically be calibrated in-situ, in-situ calibration was near-impossible in practice because: a) these positional shifts can be difficult to identify, and b) because stereopair calibration previously required a strict, controlled environment and a skilled technician—requirements that are practically impossible (e.g., extremely expensive and logistically difficult) to obtain once the system is deployed in the field, particularly in consumer systems.

To resolve this issue, the inventors have invented a method for dynamic, in-situ stereocamera calibration. The inventors have discovered that, in a properly calibrated stereovision system, objects that are very far away would be imaged on the same (or nearly the same) “pixel” of the image sensor (e.g., same pixel if you overlaid the left camera and right camera frames). Calibration error (e.g., relative camera position shift) can be detected when the far away points (infinite points) in the image do not fall on same pixel (e.g., disparity greater than threshold value, such as 0). These infinite points can also be used as reference points to calibrate the system, wherein applying the corrected calibration parameters to the infinite points reduces the disparity below a threshold value. The inventors have further discovered that infinite points can be identified as objects (or other fiducials) for which the disparity, or relative position, of the objects does not substantially change between successive images, particularly when the stereocamera system is translating.

The inventors have further discovered that close points (e.g., objects that are close enough to change between successive frames during system translation) can be used to correct for translational shifts, leveraging the assumption that the non-epipolar coordinate values (e.g., in 3D point space) from the left image should be equal to the non-epipolar coordinate values from the right image for a given point. Calibration error can be detected when a point's non-epipolar coordinate values are mismatched between the left and right images, and a calibration correction factor can be determined based on the mismatch. In other words, in some embodiments the points should only be translated on one axis, which is the same axis the cameras are translated on. Translation of the points on the other axis is detected as an error that can be corrected. Accordingly, in some embodiments the stereocamera system is configured to have cameras translatable only on one axis (e.g., translatable along the X axis and not at all on the Y axis).

In one embodiment, a process for in-field camera calibration in a stereovision system, includes: using a plurality of cameras to capture an image pair, the image pair comprising images of a scene; a calibration circuit identifying infinite points on the images of the image pair; the calibration circuit determining a disparity amount between corresponding infinite points for each camera; and the calibration circuit determining an inverse operation to reduce the determined disparity amount between the corresponding infinite points. Identifying infinite points may include tracking a point across multiple frames on a frame-by-frame basis; and determining whether there is a frame-by-frame disparity in the tracked point above a determined threshold amount. Identifying infinite points may be performed in real time while a platform upon which the stereovision system is employed is in operation.

In some embodiments, the disparity between infinite points may be computed and analyzed over a plurality of samples before determining the inverse. Determining an inverse operation to reduce the determined disparity amount between the corresponding infinite points can include, for example, determining a coplanar correction factor. The process can further include updating calibration parameters for one or more of the plurality of cameras based on the correction factor.

In another embodiment, a process for in-field camera calibration in a stereovision system, can include: using a plurality of cameras to capture an image pair, the image pair comprising images of a scene; a calibration circuit identifying corresponding points, the corresponding points comprising a point on a first image of the image pair corresponding to a point on a second image of the image pair; the calibration circuit determining a translational disparity amount between the corresponding points for each camera; and the calibration circuit determining an inverse operation to reduce the determined translational disparity amount between the corresponding infinite points.

Determining a translational disparity amount between the corresponding points for each camera may include determining a disparity in a non-epipolar coordinate, and determining the inversion operation comprises determining whether the disparity in the non-epipolar coordinate exceeds a threshold disparity amount.

In some embodiments, determining an inverse operation to reduce the determined translational disparity amount between the corresponding points may include determining a translation correction factor. The process may further include updating calibration parameters for one or more of the plurality of cameras based on the correction factor.

In yet another embodiment, a system for in-field camera calibration includes: a plurality of cameras mounted on an operational platform; a transmitter communicatively coupled to each of the cameras; a calibration circuit comprising: a communication receiver to receive signals from the transmitters comprising image information, the communication receiver receiving an image pair, the image pair comprising images of a scene; and a processing circuit to identify infinite points on the images of the image pair, determine a disparity amount between corresponding infinite points for each camera, and determine an inverse operation to reduce the determined disparity amount between the corresponding infinite points.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE FIGURES

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a schematic representation of stereocamera system mounted to a mounting surface, which in this example is a vehicle windshield.

FIG. 2 is a schematic representation of an example stereocamera system in accordance with one embodiment of the systems and methods described herein.

FIG. 3 is a schematic representation of an example camera mounted to a mounting surface in accordance with one embodiment of the technology described herein.

FIG. 4 is a flow diagram illustrating an example process for computing calibration parameters in accordance with one embodiment of the systems and methods described herein.

FIG. 5 is a diagram illustrating an example of determining a coplanar correction factor in accordance with one embodiment of the systems and methods described herein.

FIG. 6 is a diagram illustrating an example of determining a translational correction factor in accordance with one embodiment of the systems and methods described herein.

FIG. 7 is a diagram illustrating an example architecture for a calibration circuit in accordance with one embodiment of the systems and methods described herein.

FIG. 8 is a schematic representation of an example of the axes of an image frame pair.

FIG. 9 is a diagram illustrating an example process for determining correction factors in accordance with one embodiment of the systems and methods described herein.

FIG. 10 illustrates an example of axes of an image frame pair.

The figures are not intended to be exhaustive or to limit the invention to the precise form disclosed. It should be understood that the invention can be practiced with modification and alteration, and that the disclosed technology be limited only by the claims and the equivalents thereof.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

Embodiments of the systems and methods disclosed herein can be configured to provide a stereovision system that includes a plurality of independently mounted cameras that can be installed in a number of different applications. A time-of-install calibration process can be provided that allows the installer to point the cameras in generally the same direction and then capture information such as intrinsic distortion and orientation data to enable the calibration to occur. The process can also include methods for conducting an in-field calibration routine to account for orientation changes that may occur such as, for example, by temperature, vibration, shock, aging, and so on. In some embodiments, the in-field calibration can be conducted continuously while in other embodiments it can be conducted on a periodic basis.

Although the disclosed systems and methods for stereocamera calibration can be used in a number of different applications, they are described in this document in terms of an application in which stereovision cameras are mounted on a vehicle such as an automobile, truck, bus, aircraft, floating vessel or other vehicle. After reading this description, one of ordinary skill in the art will appreciate how the stereocamera calibration systems and methods disclosed herein can be used to provide calibration in alternative applications. For example, the disclosed systems and methods may not only be used in systems that translate (e.g., vehicles, drones, sports equipment, windmills, etc.), but can also be used in static applications (e.g., buildings, facilities, etc.). The disclosed systems and methods can be used for a variety of applications such as collision avoidance, obstacle detection, navigation (including autonomous navigation), 3D video and still image capture (e.g., for entertainment, extreme sports and so on), machinery positioning and control, or for any other suitable application. The disclosed systems and methods can also be implemented for use with auxiliary systems (e.g., LIDAR, ToF, etc.). For example, the disclosed systems and methods can be used to provide a source of truth for auxiliary navigation system calibration (e.g., real-time calibration in-situ, asynchronous calibration, etc.), or otherwise used. As another example, the stereo calibration systems and methods can help bring sensors into a fused calibration with the rest of the system, and those sensors can also be a source of information used by the calibration routine to achieve higher performance.

In various embodiments, camera modules may be provided that include an imaging system (e.g., a camera) mounted in enclosures that can be mounted to the vehicle. For example camera modules can be affixed to the interior front windshield of the vehicle, mounted behind vehicle grill, included within the headlight assemblies of the vehicle, mounted on the front bumper or front fascia the vehicle or otherwise placed so as to achieve the appropriate line of sight for the imaging application. Likewise, cameras may be mounted on other portions of the vehicle such as the sides or rear of the vehicle for imaging in other directions. The cameras can be removably or fixedly attached to the vehicle component using a number of attachment mechanisms such as, for example, screws, bolts, adhesives, suction cups, bayonet mounts, and so on. In further embodiments, the cameras can be mounted in a manner such that their pointing angle can be fixed or adjustable. For example, gimbal or other like adjustable mounts can be used.

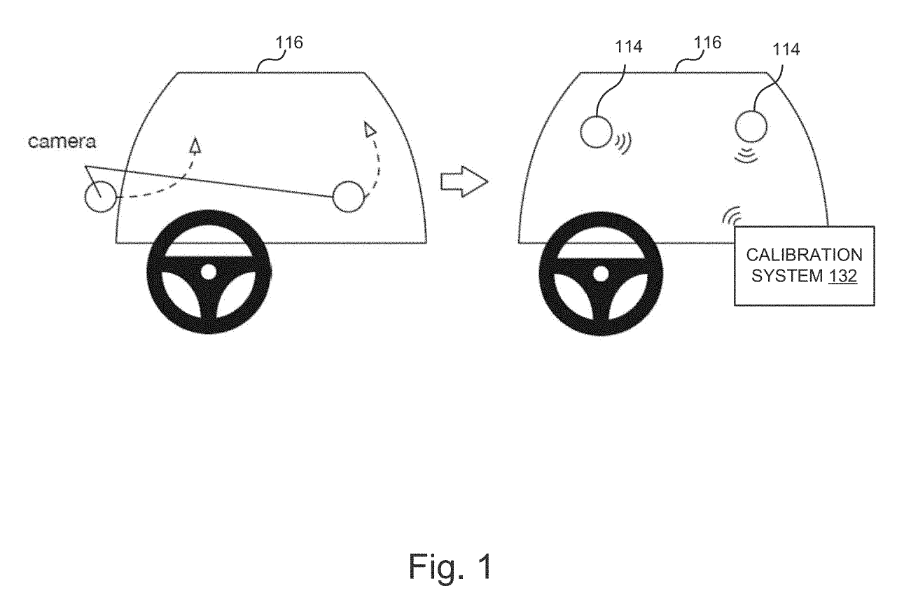

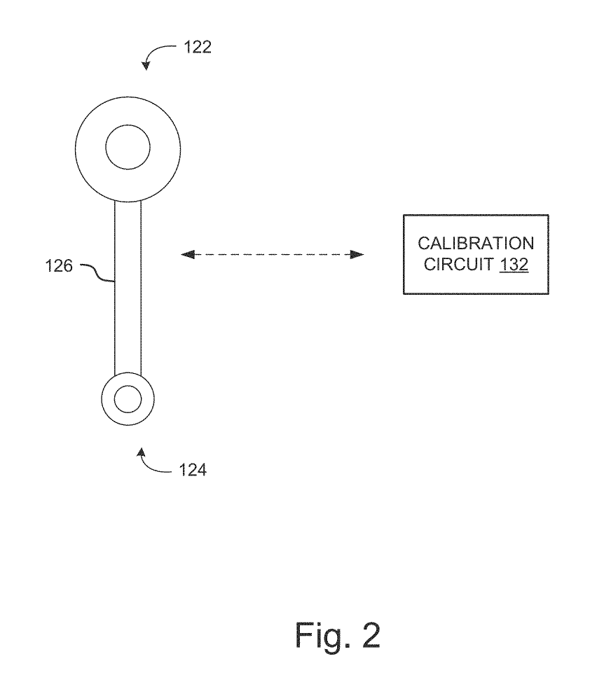

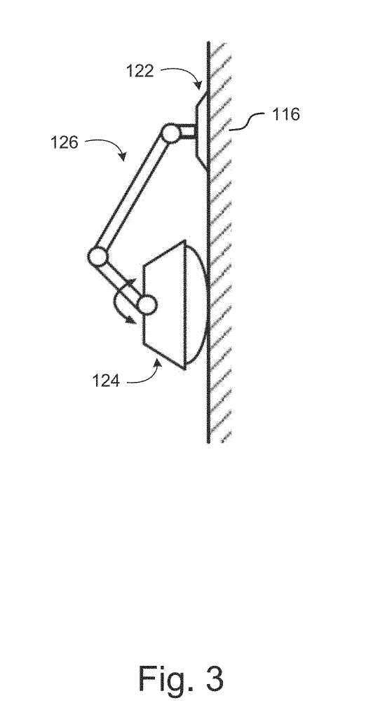

An example placement is shown in FIG. 1, which shows placement of two cameras 114 in the upper corners of a vehicle windshield 116. However, as described above, other camera placements are possible. FIG. 2 shows an example of a camera and mounting mechanism in accordance with one embodiment of the systems and methods described herein. In this example, camera 124 is attached to a mounting mechanism 122 via a mounting arm 126. Another example of this is shown in FIG. 3, illustrating a side view of a mounting bracket 122 mounted on a windshield 116 with camera 124 attached to the mounting bracket via an articulating mounting arm 126. As seen in this example, mounting arm 126 includes hinges such that the position of the camera can be adjusted relative to mounting bracket 122 and windshield 116. The arrow also indicates that camera 124 (or the body within which it is mounted) can be swiveled or tilted relative to mounting arm 126. Although one degree of freedom is illustrated in FIG. 3, camera 124 can be attached to mounting arm 126 with multiple degrees of freedom. For example a hinge mount, multiple-hinge mount, ball and socket mount, or other attachment mount can be used to attach camera 124 to mounting arm 126. Likewise, the hinges in mounting arm 126 can be configured to provide one or more degrees of freedom to provide the desired flexibility in positioning camera 124 relative to mounting bracket 122.

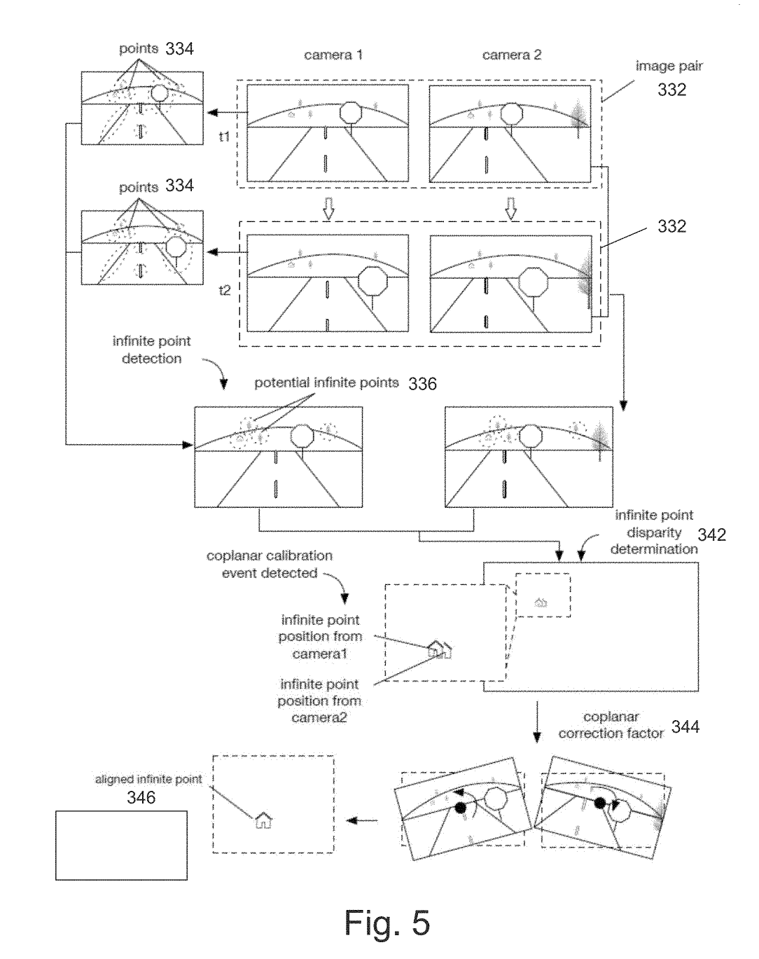

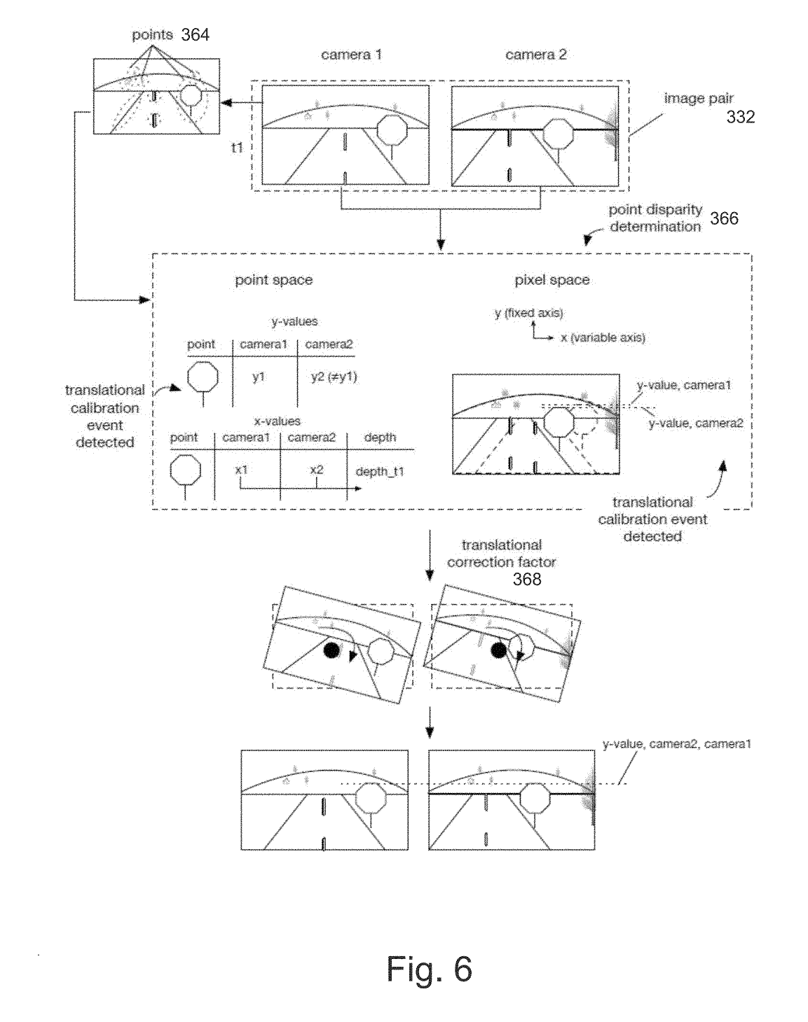

As the above examples described with reference to FIGS. 1-3 illustrate, there are a variety of mechanisms that can be used to mount the stereovision cameras in the desired application. The above-described embodiments are examples only, and other attachment and mounting mechanisms can be provided. Having thus described an example mounting mechanisms for stereovision cameras, example calibration methods are now described. In one embodiment, an in-situ stereocamera calibration method can includes the process of receiving an image pair from a stereocamera system. In one embodiment, a processing system (e.g., calibration system 132) can be included to determine point parameters for each of a set of points in the image pair. The processing system can then use the determined point parameters to calculate a correction factor. The correction factor can then be used to recalibrate the stereocamera system. In various embodiments, the calibration can include calibrating for camera co-planarity shifts (described in more detail below with reference to FIG. 5), and it can include calibrating for camera translational shifts (described in more detail below with reference to FIG. 6).

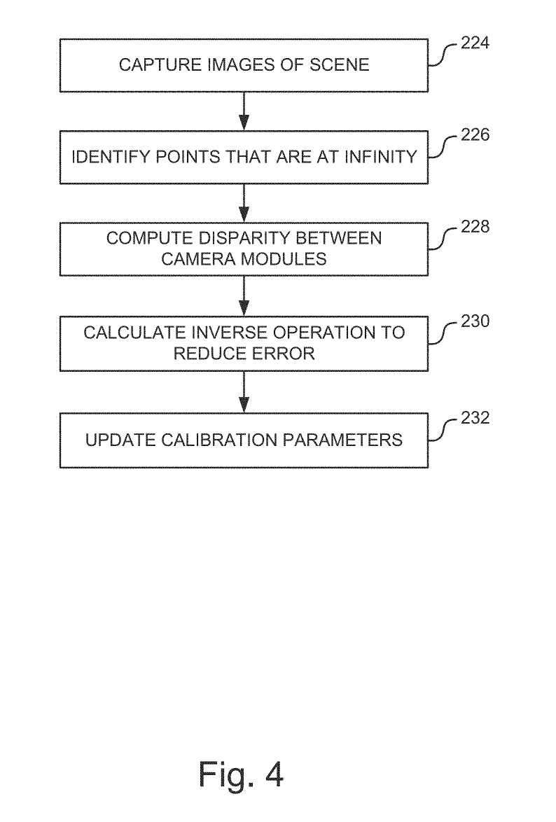

FIG. 4 is a diagram illustrating an example process for in-field calibration in accordance with one embodiment of the systems and methods described herein. Referring now to FIG. 4, at operation 224, a pair of stereovision cameras are used to gather images of a scene. For example, in the case of vehicle applications, the imaged scene may be that of a roadway upon which the vehicle is traveling. In other applications, the imaged scene may be the environment within which the apparatus is operating (e.g., a workspace in the case of a tool or machinery, a playing ‘field’ in the case of sporting goods, etc.).

At operation 226, the calibration system identifies points that are at infinity. The determination regarding what is defined as “infinity” can vary based on the application or based on the situation within a given application. For example, infinity can be chosen as a point at 300 m away for a 100 m depth target. An infinite distance for a given imaging system can be computed based on focal length, resolution and baseline (distance between cameras on the epipolar axis). For example, a longer focal length results in a longer infinite distance; a higher resolution results in a longer infinite distance; and a longer baseline results in a longer infinite distance. Accordingly, an example of “choosing” an infinite distance for a given system would be downscaling the images so they are at a lower resolution to yield a closer infinite distance.

One technique for identifying points at an infinite distance is to track multiple points in the image frame by frame and to identify points that don't have disparity frame-to-frame, or that only have a small amount of frame-to-frame disparity. Because points at greater distances will not change as much over time (due to their distance) these distant points won't have a large frame-to-frame disparity and can be deemed to be points at infinity. In some embodiments, the disparity can be calculated at multiple points in time and the disparities measured over time can be compared to determine whether and how much the disparity is changing over time. If the change in disparity over time is zero, or below a defined threshold, the measured point can be deemed to be a point at infinity.

In some embodiments, the points may be self-correlating (i.e., they are unique points in the image frame). For example, in vehicular applications, road signs can be good candidates for such points. In various embodiments, tracking points and determining which points are at infinity can be done in real time as the vehicle is traveling along its course. Likewise, in machinery or sporting goods applications, the process can take place in real time while the machine tool or sporting implement is being moved or otherwise translated. In other embodiments, the points may have low self-correlation (for example, a group of points look similar to each other and must be evaluated as a set because the self-correlation peaks are not unique).

In some embodiments, the entire frame can be analyzed to determine points at infinity, while in other embodiments cost and computational time can be reduced by limiting the analysis to specific subregions of the image frame instead analyzing the entire frame. As one example, in vehicular applications faraway points are typically those points above the roadway (in the case of an automobile) and therefore, in such applications, the system can be configured to analyze only the top half of the frame to optimize the search for points at infinity. In other embodiments, other optimization routines can be used. For example, semantic segmentation may be used to sort pixels by object class and select areas of the frame to analyze accordingly.

In further embodiments, the infinity point, or goal, can be changed over time to reduce the goal if the system is unable to resolve points at a greater distance. For example, if the system is unable to resolve 300 m as infinity, the system can reduce that distance to 100 m an attempt to resolve points at 100 m as being at infinity. Other distances, and other step sizes for reduction can be implemented. Changes to what is deemed to be at infinity, and therefore changes in depth performance, can be communicated to the user of the system. Additionally, depth calibration can be augmented by also using a close object in the process. For example, a hood ornament, antenna or other fiducial on the hood of an automobile can be used. In yet further embodiments, the process can begin by looking at closer objects and moving to objects farther away to determine objects at infinity.

At operation 228, the identified infinite point or points identified are used to compute a disparity between the images from the two cameras. In various embodiments, the infinite points may be a plurality of independent points distributed relative to a single point on the frame such as the optical center of the frame. The disparity between the camera modules can be compared. It can be analyzed over time to gain confidence through multiple sampling and analysis of points. In one embodiment, the disparity can be computed as a rotation error, and the amount of rotation error can be calculated between corresponding infinite points imaged by both of the cameras.

At operation 230, the system calculates an inverse operation to reduce the error. In the case of a rotation error, an inverse rotation that would bring the determined disparity of the points to zero is calculated. When applied, such an inverse rotation would effectively calibrate out the measured error. At operation 232, these newly determined calibration parameters can be updated for the system. In some embodiments, the calibration parameters can be used for operation of the system as configured. In other embodiments, the determined rotation error can be used by an operator to physically rotate either or both cameras to accomplish the determined inverse rotation.

As noted above, calibration can be used for coplanarity or translational shifts. FIG. 5, illustrates one example of calibrating for camera coplanarity shifts in accordance with one embodiment of the systems and methods described herein. In this example, the calibration system (e.g. calibration system 132) receives an image pair 332 from the two system cameras, camera 1 and camera 2 (e.g. cameras 114). The calibration system analyzes points 334 to identify infinite points 336 from the first and second images 332 using, for example, the process described above with reference to FIG. 4. This can be done on a frame-by-frame basis across multiple frames as the vehicle is traveling as illustrated in FIG. 5.

The calibration system can further determine a disparity between the infinite point positions in the first and second images 332 as shown at 342. In some embodiments, this can be determined over successive frames. In response to the point position difference between successive frames exceeding a threshold difference, the calibration system can determine a coplanar correction factor 344 (e.g., a rotation) that corrects or at least reduces the disparity. The calibration parameters can then be updated based on the correction factor. In a specific example, the correction factor can be a correction rotation, wherein updating the calibration includes rotating the images in opposite directions by the correction rotation before image registration and/or depth calculation. As shown in the example of FIG. 5, the applied correction results in an aligned infinite point 346.

FIG. 6 illustrates a second example for camera calibration in accordance with one embodiment of the systems and methods described herein. In this example, the method includes calibrating for camera translational shifts. This process begins by the calibration system (e.g. calibration system 132) receiving a first and second image pair 332 from a first and second camera, camera 1 and camera 2, (e.g. cameras 114) of the stereocamera system. The calibration system identifies points 364 from the first and second images of the image pair 332. The calibration then determines a disparity for each point as shown at 366, and determines whether disparity in a non-epipolar coordinate exceeds a threshold disparity for the point (also illustrated at 366).

In response to the disparity in a non-epipolar coordinate exceeding a threshold disparity for a point, the calibration system determines a correction factor that corrects the non-epipolar coordinate disparity as shown at 368. The calibration system then updates the calibration based on the computed correction factor. In a specific example, the correction factor can be a correction rotation, wherein updating the calibration includes rotating the images in the same direction by the correction rotation about the other non-epipolar axis before image registration and/or depth calculation.

In some embodiments of the calibration systems and methods, each camera may be modeled as having its own reference frame that can be described by a 3D coordinate system (e.g., x,y,z). A step in the stereo calibration process is to de-rotate one camera with respect to the other such that it can be described only by a translation. As a result one camera can be fully describe as being some [X, Y, Z] distance away from the other. The infinite point calibration method allows the system to maintain this relationship between cameras and remove any rotational error between them.

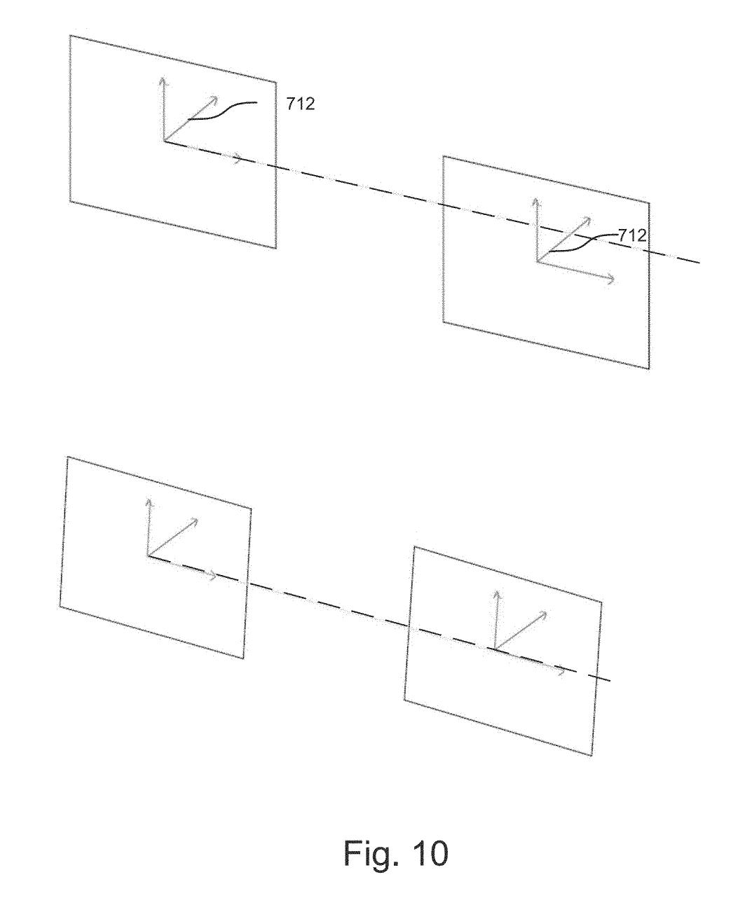

A second part of stereo calibration that may be implemented to achieve computational efficiency is to ensure you and the “translation” described above only has one component (e.g., an X component). That is, camera 2 is ideally only be to the left or right or camera 1, and not also above/below or in front/behind. [X, 0, 0]. Any two cameras with a purely translational relationship can be rotated identically. For example, assume a case where camera 2 is slightly below camera 1 (as illustrated in FIG. 10). If both cameras are rotated clockwise around the Z axis 712, their X-axes will line up and change the [X, −Y, 0] translation to [X′, 0, 0].

The calibration methods described herein may be performed with a stereocamera system (e.g., as shown in FIG. 1), but can alternatively be performed with any other suitable optical system. As illustrated in the examples described above, stereocamera system can include: two cameras, a mounting mechanism, and a control system (example shown in FIG. 1), but can additionally or alternatively include any other suitable set of components. The stereocamera system can be configured to be mounted to a diverse set of mounting surfaces, and can be calibrated in-situ (e.g., during operation), in real- or near-real time, but can additionally or alternatively perform any other suitable functionality. The cameras of the system may be independently mountable, but can also be mounted in fixed relation to one another.

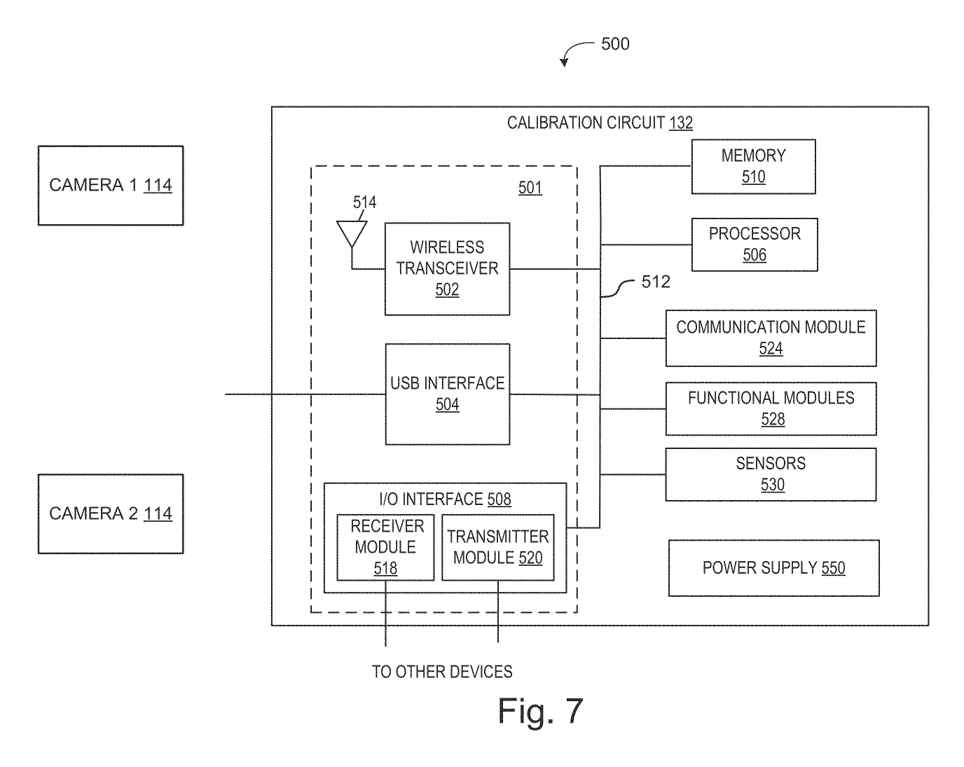

FIG. 7 illustrates an example of a stereocamera system in accordance with one embodiment of the systems and methods described herein. This example illustrates two cameras 114 communicatively coupled to calibration system 132. The cameras 114 of the stereocamera system function to capture images and can be implemented using any of a number of different types of image sensor including, for example, CCD (charge-coupled device) and CMOS (complementary metal oxide semiconductor) image sensors. The images captured by cameras 114 may be dewarpable images (e.g., images that can be rotated), but can alternatively be any other suitable type of image. The stereocamera system may, in some embodiments, include two cameras 114 as shown in this example, but can alternatively include a single camera (e.g., wherein different portions of the image sensor are analyzed in lieu of a first and second camera), more than two cameras (e.g., wherein the camera population can be split into exclusive or overlapping camera pairs), or any suitable number of cameras. Cameras 114 may be separate from each other (e.g., independently mounted), but can alternatively be fixedly mounted together for installation as an integrated package or otherwise configured.

Cameras 114 may be installed (e.g., mounted) such that the fields of view of the first and second camera overlap, but can be otherwise mounted. Cameras 114 can have the same parameters (e.g., lens, lens distortion, focal length, image sensor format, principal point, wavelength sensitivity, number of pixels, pixel layout, etc.), or have different parameters (wherein the different parameter values can be known or unknown). Cameras 114 can have wide angle lenses (e.g., fisheye lens, wide-angle lens, ultra-wide angle lens), normal lenses, long focus lenses, medium telephoto lenses, narrow angle lenses, super telephoto lenses, or any other suitable lens.

The mounting mechanism 122 (examples of which are shown in FIGS. 2 and 3) of the stereocamera system 500 releasably or fixedly attaches the camera(s) 114 to a mounting surface at a mounting point. The mounting surface can be a vehicle windshield as seen in the example of FIG. 1, or other suitable location depending on the application. For example, the mounting surface can be a surface on the interior or exterior of: a vehicle body or shell (e.g., of a drone, car, boat, train, etc.), a windshield, a building, a tool or machinery, a sporting good implement, or any other suitable surface. The mounting point may be outside of camera's field of view, but can alternatively be within camera's field of view (e.g., system can adjust camera position based on portion of mounting mechanism visible in the image). Cameras 114 can be mounted horizontally (e.g., define a left and right camera, example shown in FIG. 1), vertically (e.g., define a top and bottom camera), or in any suitable orientation relative to one another. The stereocamera system 500 can include a mounting mechanism for each camera 114 (example shown in FIGS. 2 and 3), multiple mounting mechanisms 122 for each camera 114, a single mounting mechanism 122 for multiple cameras 114, or otherwise pair mounting mechanisms with the cameras. The mounting mechanism 122 can removably or substantially permanently mount the camera to the mounting surface. The mounting mechanism 122 can be substantially rigid and statically mount the camera to the mounting surface, be actuatable and actuatably mount the camera to the mounting surface (e.g., to rotate or otherwise change the orientation of the camera relative to the mounting surface, translate the camera 114 along the surface, etc.), or otherwise mount the camera 114 to the surface. In one example, the mounting mechanism 122 can include a multi-position joint that incrementally adjusts the camera's position about a rotational axis perpendicular the camera's optical axis (example shown in FIG. 3), but can additionally or alternatively adjust the camera's position about any suitable rotational axis. The mounting mechanism 122 can be a screw, clip, suction cup, adhesive, active or passive actuation mechanism (e.g., gimbal, rail, set screws, ratcheting system, etc.), or any other suitable mounting mechanism. The mounting mechanism 122 may be connected to the associated camera(s) by the camera housing, but can be otherwise connected to the associated camera(s). The mounting mechanism 122 can additionally include alignment indicators (e.g., laser or liquid levels, hatch marks, etc.) that can be used by a user to align one or more cameras.

The calibration system 132 may perform the calibration methods using images detected by the mounted cameras. The calibration system 132 can be part of the operational platform, or host system, to which the cameras are mounted. For example, the vehicle ECU, vehicle navigation system, or other vehicle processing system can also implement the functionality of calibration system 132. Similarly, other platforms and other applications can implement the functionality of calibration system 132. In other embodiments, the calibration system 132 may be separate from the operational platform. For example, the calibration system 132 may be removably coupled to the operational platform, or it may be a separate computing system from the operational platform. Calibration system 132 may also be an aftermarket computing system headed to the vehicle after manufacture (e.g., as a retrofit or aftermarket upgrade), or it be any other suitable control system.

In the example illustrated in FIG. 7, calibration system 132 includes a communication module 501. In this example, communication module 501 includes a wireless transceiver 502 with an antenna 514, a USB interface 504 with appropriate USB ports (not illustrated) and a wired I/O interface 508. Wireless transceiver 502 can include a transmitter and a receiver (not shown) to allow wireless communications via any of a number of communication protocols such as, for example, WiFi, Bluetooth, near field communications (NFC), Zigbee, and any of a number of other wireless communication protocols whether standardized, proprietary, open, point-to-point, networked or otherwise. Antenna 214 is coupled to wireless transceiver module 202 and is used by wireless transceiver module 202 to transmit radio signals wirelessly to wireless equipment with which it is connected. These RF signals can include information of almost any sort that is sent or received by calibration system 132 to/from cameras 114 and other entities.

Wired I/O interface 508 can include a transmitter 520 and a receiver 518 for hardwired communications with other devices. For example, wired I/O interface 508 can provide a hardwired interface to other components, including components of the platform with which the system is implemented. Wired I/O interface 508 can communicate with other devices using Ethernet or any of a number of other wired communication protocols whether standardized, proprietary, open, point-to-point, networked or otherwise.

The calibration system 132 can be packaged with the cameras 114, arranged in a separate housing from the cameras 114, or be otherwise coupled to the cameras 114 via communications interface 501. The calibration system 132 can include: a processor 506, memory 510, communication circuitry 524, and functional modules 528. These components in this example are communicatively coupled via a bus 512.

The processing system 506 can include a GPU, CPU, microprocessor, or any other suitable processing system. The memory 510 may include one or more various forms of memory or data storage (e.g., flash, RAM, etc.) that may be used to store the calibration parameters, images (analysis or historic), point parameters, instructions and variables for processor 506 as well as any other suitable information. Memory 510, can be made up of one or more modules of one or more different types of memory, and in the illustrated example is configured to store data and other information as well as operational instructions that may be used by the processor 506 to operate calibration system 132.

One or more functional modules 528 can also be included to perform/control any other functions that might be performed by calibration system 132. The calibration system 132 can communicate with camera(s) 114, secondary sensing systems, user devices, remote computing systems, or any other suitable endpoint.

The functionality of calibration system 132 can also include a dewarping circuitry that dewarps the images (e.g., using a sparse map dewarp method or any other suitable dewarping method), a transformation circuitry that automatically applies the calibration parameters to the images (e.g., pre-, post-, or during-dewarping), or any other suitable system. The transformation and dewarping circuits can be processor-based circuits, digital modules or dedicated circuitry, and can be specific to a camera or the associated camera stream, be shared between a camera pair, be shared across all cameras in the system, be shared across all cameras (e.g., of a system population), or be otherwise paired with a camera or image stream.

A power supply 550 can be included to provide power to calibration system 132 as well as to the cameras, depending on the interface to the cameras. In some embodiments, power supply 550 can be a dedicated power supply for the calibration system 132. In other embodiments, power supply 550 can be an existing power supply used to provide power to other components of the platform. For example, where the calibration system 132 is installed in a vehicle, power supply 550 can include connections and circuitry needed to receive power from the vehicle and convert that power to the levels needed for calibration system 132. Power supply 550 can include the appropriate AC to AC, AC to DC, DC to AC, or DC to DC power conversion needed to supply the appropriate power to the system.

Power supply 550 can include a battery (such as, e.g., Li-ion, Li-Polymer, NiMH, NiCd, NiZn, NiH₂, rechargeable, primary battery, etc.), a power connector (e.g., to connect to AC Mains, wires, vehicle diagnostic port connector, etc.), an energy harvester (e.g., solar cells, piezoelectric system, etc.), or include any other suitable power supply.

Sensors 530 can be included to provide auxiliary information for use in dynamic calibration (e.g., for infinite point classification or identification), and can include temperature sensors, pressure sensors, orientation sensors (e.g., magnetometer, IMU, gyroscope, altimeter, etc.), location sensors (e.g., GPS, trilateration), light sensors, acoustic sensors (e.g., transducer, microphone), or any other suitable sensor. Calibration circuit 132 can use dedicated sensors or sensors that are part of the platform (e.g., the vehicle) with which the stereo vision system is implemented. Other information that can be used by the calibration system 132 can include, for example, information about the platform (e.g., vehicle make, model, serial number, dimensions, etc.), Vehicle-to-Vehicle (V2V) or Vehicle-to-Infrastructure (V2I) information (which can be used, for example, to help identify suitable candidate objects for infinite point detection), computer vision algorithm pipelines (e.g., road detection, horizon, object detection), platform movement information (e.g., in the case of a vehicle speed information obtained through GPS or vehicle sensor data, for example).

The calibration system 132 may also include outputs, which may be human or machine detectable. These outputs can include, for example, lights, speakers or other audio emitters, display screens, communication module 501, or any other suitable output.

Embodiments of the in-situ stereocamera calibration systems and methods may be used to automatically calibrate a stereocamera system. The method can additionally enable independent camera installation for a stereocamera system. The method may be performed with systems in accordance with the examples discussed above, but can alternatively be performed with any other suitable system. The calibration can be performed upon installation (e.g., without prior stereocalibration, such that the method generates the initial stereocalibration), iteratively during host system operation (e.g., using a previously determined set of stereocalibration parameters to recalibrate the system or no predetermined calibration parameters), at a predetermined frequency, or at any other suitable time.

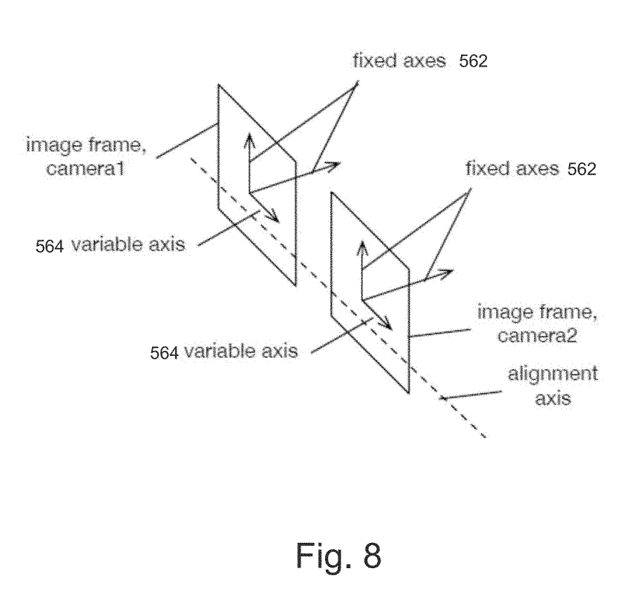

In various embodiments, the systems and methods described herein may be used to bring the stereocamera system into calibration. A calibrated stereocamera system may have first and second fixed axes 562 and a variable axis 564 (example shown in FIG. 8). The fixed axes 562 may be assumed to be equal or constant between the image frames of the image pair when performing the depth calculation, while the point disparity (between the image pair) in the variable axis 564 may be used to determine the point's depth or distance from the stereocamera system. The variable axis may be parallel the camera alignment axis, but can alternatively be any other suitable axis. In one example, the fixed axes can be a non-epipolar axis (e.g., x axis, parallel to the x coordinate) and the epipolar axis (e.g., z axis, parallel to the z coordinate), while the variable axis can be the other non-epipolar axis (e.g., y axis, parallel to the y coordinate). It is noted that identification of the axes is by way of example only, and other axis identification paradigms may be used. It is also noted that processes for calculating and calibrating out an error in one axis may likewise be applied for errors in another axis.

A calibrated system can generate a first and second set of point parameters for a given point, determined from the respective images of an image pair, wherein the point parameters would share a common non-epipolar coordinate value (e.g., along the first fixed axis), having aligned epipolar axes (e.g., along the second fixed axis), and have disparate non-epipolar coordinate values (e.g., along the variable axis), wherein the disparity can be mapped to depth. The method can additionally determine when the system is out of calibration. In one variation, the system is considered out-of-calibration when a disparity in the fixed axes exceeds a threshold disparity (e.g., 0). The threshold disparity can be set based on the accuracy desired from the stereocamera system.

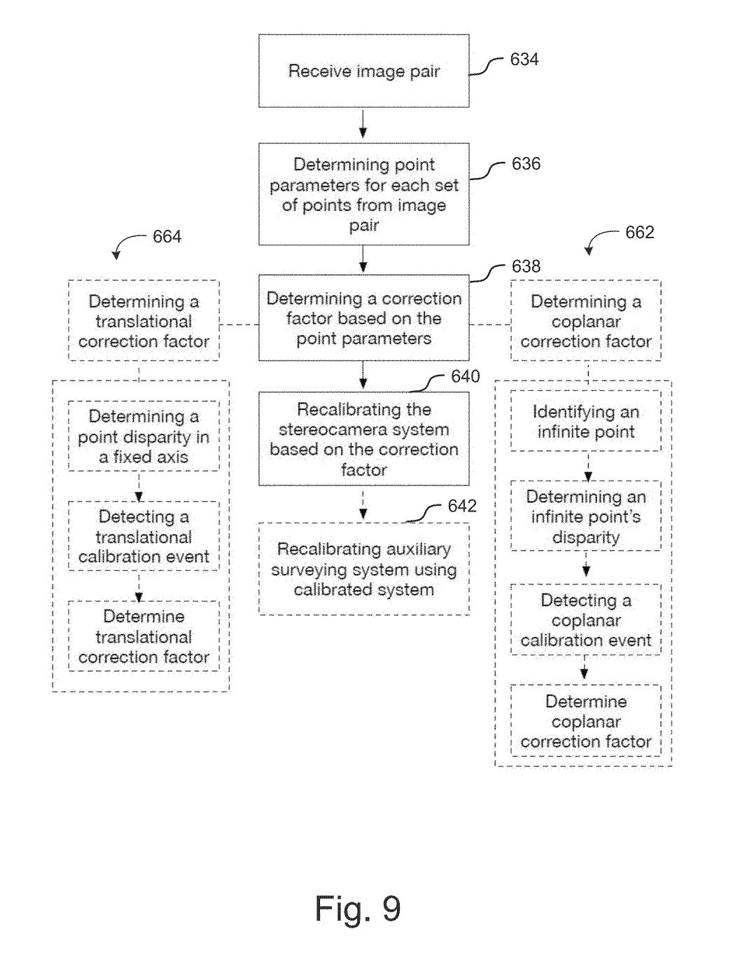

FIG. 9 illustrates another example of a calibration process in accordance with one embodiment of the systems and methods described herein. At operation 634, and image pair is received from the cameras. At operation 636, point parameters for sets of points from the image pair are determined. At operation 638, a correction factor can be determined based on the point parameters. As described above with reference to FIGS. 5 and 6, embodiments can be implemented to determine a coplanar correction factor (process 662 and FIG. 5) and a translational correction factor (process 664 and FIG. 6). As described above with reference to FIG. 5, determining a coplanar correction factor 662 includes identifying an infinite point, different determining disparity for the infinite point and then detecting a coplanar calibration event to determine a coplanar correction factor. As described above with reference to FIG. 6, determining a translational correction factor includes determining a point disparity in a fixed axis, detecting a translational calibration event in determining a translational correction factor.

The methods described herein can be performed in real-time, near-real time, or asynchronously with image sampling and/or system operation. The methods may be performed in the field (e.g., in-situ with the system mounted to the platform with which it is being used, and in some embodiments can be even performed under the end-users control, etc.). The methods may also be performed during platform (i.e., host system) and stereocamera system operation (e.g., while the vehicle is moving, while the tool is operating, while the implement is translating, while sampling images, etc.). In still other embodiments, the methods may be performed at the factory, at a maintenance shop, or at any other suitable location asynchronously with the operational platform and asynchronously with stereocamera system operation in-situ. The method may be performed by the calibration system 132, but can be performed by any other suitable system configured to perform the functions described herein. Processes of the methods described herein may be performed sequentially, but can alternatively be performed in parallel or in any other suitable order. Multiple instances of the method (or portions thereof) can be concurrently or serially performed for each stereocamera system.

Systems and methods described herein may be used to characterize and calibrate the systems for intrinsic image distortion such as distortion through platform characteristics (e.g. a vehicle windshield) and the camera lens. In some embodiments, the intrinsic image distortion is assumed to not change over time, while in other embodiments it can be assumed that these values may change as well (assuming, e.g., there is an algorithm to correct for the intrinsic changes). Further embodiments may also assume that translational parameters (e.g., distance between the cameras in X, Y and Z), may also be change or not change in the field over time.

In various applications, an initial calibration can be performed to calibrate for one or more of the intrinsic parameters, translational parameters (e.g., how the cameras are positionally related in space) and rotational parameters (e.g., the amount by which the cameras may be out of coplanarity). In some embodiments, the initial calibration may use a combination of mechanical and software calibration to correct for deficiencies and to store the initial calibration parameters. In some embodiments, it is assumed that rotational parameters will change in the field over time, although other embodiments may assume that the rotation parameters will be fixed.

The stereocamera system may include a camera pair such as those described above, but as will be appreciated by one of ordinary skill in the art after reading this description, other embodiments can include any other suitable stereocamera or multi-camera system. The image pair received from a stereocamera system by the calibration system can include sufficient data to allow the system to perform functions such as, for example, depth analysis, disparity detection, and recalibration.

The image pair may be received by the calibration system 132 directly or indirectly from the cameras, but it may also be received by any other suitable system. In one example, receiving an image pair may include transmitting the images sampled by the camera to the calibration system 132 through the communication module 501, wherein the control system performs the methods using the images and outputs depth information. However, the image pair can be retrieved from storage, from a communications access point or relay, or via other means. The image pair may include a first and second image sampled by a first and second camera, respectively. However, any suitable number of images (e.g., one, three, etc.) sampled by any suitable number of cameras (e.g., the same camera, different cameras, etc.) can be received. The images of the image pair may be sampled at the same time (e.g., operated on a common clock) or within a threshold time difference of each other (e.g., within 1 ms, 0.1 ms, etc.), but can be sampled asynchronously or at any suitable time. The images may be received as they are sampled (e.g., continuously, as a stream), but can be batched, buffered, stored for later use, or otherwise delayed.

The operations of determining point parameters for a set of points from the image pair can include, for example, determining points from the image pair, and determining point parameters for some or all of the determined points based on the image pair. Determining point parameters for a set of points from the image pair extracts information from the images for functions such as, for example, depth analysis, recalibration and disparity detection. These functions may be performed for any or all of the image pair received by the calibration system, and as noted may be performed in real- or near-real time, at a predetermined frequency, at a predetermined time, or at any other suitable time. In one embodiment, point parameters may be periodically determined for newly sampled image pairs, to monitor system health. If a disparity is detected, then the system can be configured to perform these functions for each subsequent image pair. This technique can help to conserve processing resources.

The determined points can be used to identify candidate points for disparity analysis and recalibration. This may be performed independently for each image of the image pair, but in some embodiments point identification in the second image may be dependent upon the points identified from the first image. As a further example, the process may include searching the second image for corresponding points that appeared in the first image (e.g., the point corresponding to the same part of an object), or points that are otherwise related. A point can be, for example, an object in the image (e.g., tree, road sign, etc.), an portion of an object in the image (e.g., part of a tree, road sign, etc.), a feature in the image (e.g., edge of an object), a region of the image (e.g., pixel for pixel grouping), a point in 3D point space (e.g., wherein the features or objects are converted into a point cloud using the image pair and a prior set of calibration parameters), or any other suitable data structure. Points can be determined (e.g., detected) using feature detection methods, such as, for example, blob detection, edge detection, ridge detection, corner detection, SIFT (scale invariant feature transform), thresholding, Hough transform, or object detection methods (e.g., appearance based methods, feature based methods, genetic algorithms, template matching, etc.), template matching (e.g., matching a stop sign template to a stop sign in the image), applying a prior set of calibration parameters (e.g., a predetermined triangulation or projection map); or otherwise determined.

The point determination methods can be predetermined methods. In other embodiments, the point determination methods can vary, based on, for example, factors such as vehicle velocity, whether infinite points are detected within a threshold period of time, and so on. Additionally or alternatively, the parameters used by the point determination method can remain constant or vary. For example, in one embodiment, the analysis resolution may be decreased when too many infinite points are detected (e.g., a threshold of points is exceeded). In a specific example, detecting the points may include applying plane detection to the image to identify the horizon, and applying object detection to the image region above the horizon to identify infinite points (and/or applying object detection to the image region below the horizon to identify close points). Additionally or alternatively, the points can be received from an auxiliary system (e.g., other navigation system, stereocamera system of a preceding vehicle within a threshold distance, such as a short-range communication , etc.), or otherwise determined.

Point parameters can be used to extract information about the points. Point parameters may be determined for each identified point, but can be identified for a subset of points (e.g., only close points, infinite points, or other analysis points), or be determined for any other suitable point population. Point parameters may be determined from the image pair (e.g., from the images themselves), but can alternatively or additionally be determined by an auxiliary system, wherein the object or feature appearing in the images inherits the point parameters for the corresponding object or feature identified by the auxiliary system, or be otherwise determined. Point parameters may be determined from each individual image (or image portion) of the image pair, such that each point that is shared between the two images is associated with two sets of point parameters (e.g., one from the left image, one from the right image). However, a single set of point parameters can be determined for each point. However, each point can be associated with any suitable number of point parameter sets, determined from any other suitable set and/or number of images. Point parameters can be: a pixel coordinate in the image, the point's position in 3D space (e.g., position vector, x/y/z coordinates, rotation, etc.), the point's depth (e.g., distance from the stereocamera system), any subcomponent of the above (e.g., the x-coordinate value of the point's 3D position), or any be any other suitable parameter characterizing the point. The point parameters may be determined by applying a set of prior calibration parameters (e.g., predetermined transform map, which can be determined through initial system calibration, prior instance of the method, etc.) to the images, but can alternatively or additionally determined by applying monocular cue methods (e.g., shape-from-x methods, using silhouettes, shading, or texture, such as Lambertian reflectance), or by applying any other suitable set of methods to the images of the image pair.

The processes for determining a correction factor may be used to determine the factor that corrects for changes in camera position after the last calibration. The correction factor can be a rotation, translation, scaling factor, constant, or any other suitable adjustment. The correction factor can be a constant, variable factor (e.g., based on the point position in the image or 3D space), or be any other suitable factor. One or more correction factors can be determined from each set of image pairs. The correction factor may be determined based on images recorded by the stereocamera system, but can alternatively or additionally be received from or determined based on information from an auxiliary source (e.g., an auxiliary on-board navigation system, another vehicle's stereocamera system, etc.), or otherwise determined.

The correction factor can correct for factors such as, for example, translational position parameters (e.g., distance between the cameras; can shift due to temperature, mounting changes, etc.), coplanar position parameters (e.g., relative camera coplanarity; relative roll, yaw, pitch of the cameras; changes due to mounting surface warp, vibration, etc.), or any other suitable camera parameter.

In one variation, determining a correction factor includes determining a coplanar correction factor that adjusts the coplanarity of the image planes (example shown in FIG. 5). The coplanar correction factor may be determined using infinite points, but can alternatively be determined using close points, midpoints, or any other suitable set of points. As shown in FIGS. 5 and 6, determining the coplanar correction factor may include, for example, identifying an infinite point from the set of points, determining the disparity for the infinite point between a first and second image, detecting a coplanar calibration event, and determining the coplanar correction factor based on the disparity, wherein the stereocamera system is calibrated based on the coplanar correction factor. However, the coplanar correction factor can be otherwise determined.

Identifying an infinite point from the set of points may be used to identify reference points for use in coplanarity recalibration. This is can be performed for every image, every specified number of images (e.g., fixed or varies, such as directly or inversely with velocity), at a predetermined frequency, or at any other suitable frequency. The infinite point may be determined by the control system but can additionally or alternatively be determined by an auxiliary system (e.g., a preceding vehicle's stereocamera system, an auxiliary on-board navigation system, etc.), or by any other suitable system. One or more infinite points can be identified for a given set of images or 3D point space.

Identifying an infinite point may include, for example, identifying points with point parameters that do not change beyond a threshold amount or rate (e.g., 0, 0.05 m in the y-coordinate, etc.) across a threshold number of sequential image frames (e.g., two successive images, 10 successive images, images recorded over 4 seconds, etc.). For example, this can include: tracking a point across a time-ordered set of images, determining a point position change between the successive images, and identifying points with a position change below a threshold value as a potential infinite point (example shown in FIG. 5). The threshold value can be fixed, variable (e.g., based on velocity, location, resolution, etc.), or otherwise determined. The number of images in the set and/or the tracked time period can be fixed, variable (e.g., inversely or directly vary based on host system velocity, location, weather, etc.), or otherwise determined. When variable, the parameter (e.g., time period, number of images, other thresholds, etc.) can be: calculated, selected from a lookup table (e.g., 4 s minimum for vehicle travelling at or above 35 mph), determined using heuristics, rules, or probabilistic methods, randomly selected, or otherwise determined.

The sequential image frames may be sampled by the same camera, but can alternatively be sampled by different cameras. The sequential image frames may be sampled as the operational platform is translating above a threshold velocity (e.g., 0 mph, 10 mph, etc.), but can alternatively be sampled when the operational platform is static. Easily identifiable objects may be used in some embodiments for infinite points while the system is stationary. These may include, for example, clouds, the sun, the moon, stars, mountaintops, and so on. The operational platform velocity can be determined by stereocamera system sensors (e.g., accelerometer, GPS), the vehicle (e.g., from a vehicle data bus or transmitted from the vehicle), an auxiliary sensor system, optical flow on the image series, or otherwise determined. The threshold velocity can be fixed, variable (e.g., based on stereocamera system depth performance, whether infinite points are detected, the operational platform location, etc.), or otherwise determined.

The points (or parameters thereof) can be tracked in pixel space (e.g., tracking the point's pixel location on the image frame), point space (e.g., tracking the point's position in 2D or 3D point space), or in any other suitable virtual representation of the ambient environment or point. In one example, the image is vertically split into a set of horizontal bands, each corresponding with a distance (e.g., the top band is the furthest and the bottom band is the closest). The bands can be fixed or dynamically determined (e.g., based on system depth resolution, horizon position, etc.). A point that does not transition out of the top band within a threshold period of time or successive image frames can be classified as an infinite point. In a second example, a point with a 3D point space vector that does not change beyond a threshold change within a threshold period of time or successive image frames can be classified as an infinite point. In a third example, a point that does not shift beyond a threshold number of pixels (e.g., in position or number of pixels occupied) within the threshold time or images can be classified as an infinite point. In a fourth example, points beyond a threshold distance (e.g., 300 m) from the stereocamera system (e.g., as determined from the respective vectors in 3D point space) can be classified as infinite points. The threshold distance can be dependent upon the depth resolution of the system (e.g., 300 m for a system that resolves depth within 100 m), the location of the system, or otherwise vary. The depth resolution of the system can be fixed or variable. In the latter instance, the depth resolution can be adjusted based on the presence or density of detected infinite points (e.g., decreased when the number of infinite points falls below a threshold), the geographic location of the operational platform (e.g., wherein specific resolutions are associated with given geofences, or otherwise adjusted. Changed in depth resolution (e.g., depth performance) can optionally be communicated to a user (e.g., via a client on a user device).

Identifying the infinite point can additionally or alternatively include, for example: identifying points shared between the first and second image of the image pair; identifying points within a predetermined section of the image (e.g., the top band of the image) or volume of 3D space (e.g., volume beyond a threshold distance from the system); identifying a point matching a predetermined pattern or feature set as an infinite point (e.g., road signs occupying less than a threshold number of image pixels); classifying points as infinite points (e.g., using clustering, Baysian procedures, feature vectors, clustering, etc.), identifying infinite points by applying heuristics, rules, probabilistic methods, or other methods; or otherwise identified. The infinite point identification method can be static, dynamically updated based on historic infinite points, false positives, or false negatives (e.g., from the same stereocamera system or other systems), or otherwise determined.

The identified infinite points may be tracked in an infinite point queue (e.g., list), but can be tracked in any other suitable manner. The queue can store: the point itself (e.g., feature, object, region), the point parameter values, a point identifier, or any other suitable point information. The infinite point queue can be started after the last recalibration, and cleared after a coplanar correction factor is determined for the system. Alternatively, prior infinite point queues can be stored and used to check the new coplanar correction factors. In yet another embodiment, points in the queue are only cleared based on time. All calibration events may then be applied to the points in the queue (i.e. in one embodiment the queue is updated by applying rotations to the old points). This can make the system more stable because detected points can be used over many calibration events.

Identifying the infinite point can additionally or alternatively include: removing invalid infinite points from the set of identified infinite points. In a first variation, removing invalid infinite points includes using auxiliary inputs (e.g., vehicle type, temperature, other vehicle data, vehicle velocity, etc.) to filter out invalid infinite points. For example, potential infinite points that were not detected by other preceding or proximal vehicles' stereocamera systems can be filtered out. In a second example, potential infinite points matching a hood ornament can be removed. In a third example, potential infinite points that have lasted beyond a threshold time period or across different geographic locations (e.g., spots on the windshield) can be removed. In a second variation, removing invalid infinite points includes removing non-unique points. For example, both stop signs are removed from the infinite point list when two stop signs are identified as infinite points from the image. In a second variation, removing invalid infinite points includes removing infinite points that do not appear in both images of an image pair. In a fourth variation, removing infinite points includes removing infinite points that probabilistically (e.g., infinite points that have lower than a threshold probability of being an infinite point), heuristically (e.g., infinite point detected in close band of image, which could be indicative of a spot on the windshield), or are otherwise determined to be invalid infinite points. In a fifth variation, removing infinite points includes removing outliers from the set of tracked infinite points. Removing outliers can include applying a fit algorithm or any other suitable statistical filter to the set of tracked infinite points and removing outlying points from the considered set (e.g., points outside of predetermined number of standard deviations). The fit algorithm can include: curve fitting (e.g., using an iterative fit search, smoothing, nonlinear/linear least-squares, applying a linear solution, applying a robust estimator, etc.), or otherwise fitting the points within the tracked set of infinite points. However, invalid infinite points can be otherwise identified and removed.

Determining the disparity for the infinite point can be used to determine a metric for coplanar calibration. In various embodiments, this can be performed, for example, for every new image or image pair, when a predetermined number, density, distribution, or other spatial parameter of infinite points is reached; performed periodically (e.g., once a predetermined number of images is received); or be performed when any other suitable condition is satisfied. In one variation, the image frame or 3D point space can be split horizontally into a set of vertical bands, wherein a threshold infinite point number, infinite point density, or other sector parameter must be satisfied in each vertical band before the disparity or coplanar correction factor is determined. Alternatively, the monitored regions (e.g., bands, volumes) can be defined by a grid or otherwise defined. Different sectors can have the same shape, volume, or other sector parameter; alternatively, different sectors can have different sector parameters. The threshold sector parameter can be fixed (e.g., 2 points, 20 points, sufficient number of points for statistical confidence, etc.) or variable (e.g., based on geographic, vehicle speed, camera type, depth resolution, etc.). In a second variation, the infinite point disparity is determined when predetermined infinite point distribution about optical center (e.g., image center) is achieved. However, the disparity for the infinite point can be determined at any other suitable time.

The infinite point disparity may be determined between the first and second image of an image pair (e.g., recorded by different cameras), but can alternatively be determined between images recorded by the same camera (e.g., using structure from motion techniques, other photogrammatic range imaging techniques, or any other suitable technique), images recorded at different times, or any other suitable set of images. Determining the infinite point disparity can include: registering the infinite points between the first and second images (e.g., matching the infinite point in the first image to the infinite point in the second image) and determining the disparity between the two images for the matched infinite point. However, the infinite point disparity can be otherwise determined.

The infinite points can be registered using feature matching, or any other suitable technique. In one variation, registering the infinite points can include registering the images, then matching the features based on the image registration. However, the infinite points can be otherwise registered.

The infinite point's disparity can be determined in pixel space, point space, or any other suitable space. The infinite point's disparity can be determined along a single coordinate, or for any other suitable set of coordinates. In one variation, determining the disparity between the two images for the matched infinite point includes: determining the point's pixel position (e.g., pixel ID, pixel coordinate) on the first and second image, wherein the disparity is (or is calculated based on) the pixel distance between the point's pixel position in the first image and the point's pixel position in the second image. In a second variation, the matched infinite point's disparity can be determined based on the point's position in 3D space (e.g., be the distance between the point's position as determined from the first image vs. the point's position as determined from the second image). However, the matched infinite point's disparity can be otherwise determined.

Determining the coplanar calibration event may be used to determine when coplanar calibration is needed (e.g., when the coplanar correction factor should be determined). The coplanar correction event can be detected when the disparity between the first and second images for an infinite point exceeds a threshold disparity value; when a threshold number of infinite points have above a threshold disparity; when a threshold number of infinite points have similar disparity; when the average infinite point disparity exceeds a threshold value; or when any other suitable condition is satisfied. However, any other suitable coplanar correction event can be used.

Determining the coplanar correction factor based on the disparity may be used to determine how the system can be calibrated. The determined coplanar correction factor may be used to align the infinite points in both images of an image pair (e.g., such that the infinite points fall on the same set of pixels, example shown in FIG. 6) or in 3D space (e.g., such that the infinite point parameter values as determined from both images match). The coplanar correction factor may be a rotation about an axis perpendicular the epipolar axis (e.g., the fixed non-epipolar axis, the variable non-epipolar axis) but can alternatively rotate about any other suitable angle. Alternatively, the coplanar correction factor can be a translation, constant, or any other suitable correction factor. This can be performed when the coplanar calibration event is detected or at any other suitable time. The coplanar correction factor can be determined: once (e.g., calculated, selected), iteratively until a stop condition is met, or any suitable number of times. The stop condition can be the infinite point population's disparity mean, median, standard deviation, or other characterization falling below a threshold value, a predetermined number of iterations being met, the disparity of each infinite point falling below threshold disparity, or be any other suitable stop condition.

The coplanar correction factor can be determined by minimizing the infinite points' disparity (e.g., each individual infinite point's disparity, the mean or median infinite point disparity, etc.) below a threshold disparity value, minimizing the distribution of disparity values, achieving a desired score for the points (e.g., wherein the points are scored based on the disparity, spread across the population, etc.), or be otherwise determined. The threshold disparity value can be fixed (e.g., 0, 0.5, etc.), variable (e.g., determined based on system velocity, location, etc.), or otherwise determined. The coplanar correction factor can be determined using parameters for a single infinite point, all infinite points within the tracked set, a subset of infinite points satisfying a predetermined condition (e.g., above threshold disparity value), or using any other suitable set of points. Point parameters used to determine the coplanar correction factor can include: point disparity, point position in 3D space (e.g., depth), point pixel position, or any other suitable parameter. The coplanar correction factor can be determined for individual points or a population of points. In one example, individual correction factors can be calculated for each individual point, wherein the correction factor to be applied is determined from the individual correction factors (e.g., averaged).

The coplanar correction factors can be determined by applying an optimization technique, calculating the correction factor, using heuristics, randomly selecting a factor and iteratively testing the selected values, pattern matching (e.g., using historic factors for similar data sets), a lookup table (e.g., associating a disparity value with a correction factor value), or otherwise determined. Examples of optimization techniques that can be applied include: a simplex algorithm, combinatorial algorithm, iterative method (hessian, such as Newtons method, sequential quadratic programming, interior point methods), gradient methods (coordinate descent methods, conjugate gradient, gradient descent, subgradient methods, bundle method of descent, ellipsoid method, reduced gradient, quasi-newton methods, SPSA), interpolation method, pattern search methods, global convergence (e.g., line searches, trust regions), heuristics (memetic algorithm, differential evolution, evolutionary algorithms, dynamic relaxation, genetic algorithms, hill climbing with random restart, nelder-mead simplicial heuristic, particle swarm optimization, gravitational search algorithm, artificial bee colony optimization, simulated annealing, stochastic tunneling, tabu search, reactive search optimization), or any other suitable technique.

In a first variation, determining the coplanar correction factor includes: for each infinite point, calculating an error in the infinite point position between the right and left images for the infinite point, and determining a rotation that minimizes the error (e.g., iteratively, using gradient descent, etc.) as the coplanar correction factor.

In a second variation, determining the coplanar correction factor includes: calculating a center of mass for each image of the pair, based on the set of infinite points (e.g., in point space or pixel space) of the respective image, determining a first rotation wherein the cross product overlaps the left and right centers of mass, determining a second rotation about each image's center of mass that aligns the infinite points (e.g., minimizes the error output), and compositing the first and second rotations to arrive at the coplanar correction factor. However, the coplanar correction factor can be otherwise determined.

In another variation, determining the correction factor includes determining a translational correction factor that adjusts the separation distance between the image planes. The translational correction factor may be determined using the determined points, but can alternatively be determined using any other suitable set of points. As shown in FIGS. 5 and 7, determining the translational correction factor may include, for example, determining the disparity for the point between a first and second image of the image pair, detecting a translational calibration event, and determining the translational correction factor based on the disparity, wherein the stereocamera system is calibrated based on the coplanar correction factor. However, the translational correction factor can be otherwise determined.

The translational correction factor can be determined independent of coplanar correction factor determination, in association with coplanar correction factor determination or coplanar calibration (e.g., before, after, or during coplanar correction factor determination or coplanar calibration), or be performed at any other suitable time. The translational correction factor can be determined continuously, periodically (e.g., at the same or different frequency as coplanar correction factor determination), in response to a disparity detected in close points (e.g., disparity satisfying a condition, such as disparity along a fixed coordinate such as the y-coordinate or a disparity above a threshold difference), in response to disparity detected in both non-epipolar axes, or in response to any other suitable condition being met. The translational correction factor can be determined from the same pool of points from which the infinite points are selected, from a different point pool (e.g., generated from image pairs received before or after those generating the pool from which the infinite points are selected), or from any other suitable set of points. The translational correction factor can be determined using close points, midpoints, infinite points, all the determined points (e.g., including or excluding outliers) or a subset of the determined points (e.g., a single close point, points within the close and middle bands, random selection of points, points that have moved between distance bands, etc.).

Determining the disparity for the point between a first and second image of the image pair may be used to determine information for depth determination and/or system recalibration. The disparity for each point may be determined in a similar manner to infinite point disparity determination, but can be otherwise determined.

Detecting a translational calibration event may be used to determine when the translational parameters of the calibration parameters needs to be calibrated. In a first variation, the translational calibration event is detected when a pixel position of a known fiducial (e.g., point on the windshield, point on the lens, point on vehicle hood, etc.) changes. In a second variation, the translational calibration event is detected when a disparity in a point's fixed axis (preferably the non-epipolar fixed axis but alternatively the epipolar axis) is determined. In a specific example, when the z- and y-coordinates are fixed and the x-coordinate is variable, a translational calibration event is detected when a disparity is detected in the y-coordinate (example shown in FIG. 6). However, the translational calibration event can be otherwise determined.

Determining the translational correction factor based on the disparity may be used to determine how the system can be calibrated. The determined translational correction factor may be used to align a fixed axis of the point (e.g., within a threshold discrepancy), more preferably the fixed non-epipolar axis of a close point but alternatively any other suitable axis, but can be otherwise determined. The translation correction factor may be a rotation about the fixed non-epipolar axis, but can alternatively be a rotation about the epipolar axis or about any other suitable axis. However, the translation correction factor can be any other suitable correction factor. The translational correction factor may be determined in response to translational calibration event detection, but can be performed at any other suitable time. The translational correction factor can be determined for each point, a population of points, or for any suitable point subset. The translational correction factor can minimize the overall disparity, the disparity for each point, the mean or median disparity, or achieve any other suitable optimization goal. The translational correction factor can be determined using methods similar to the coplanar corrector factor determination as discussed above, but can be otherwise determined.

However, the correction factor(s) can be otherwise determined.

Recalibrating the stereocamera system based on the correction factor may be used to accommodate for the relative camera position changes after initial calibration, such that obstacle depths determined from subsequently sampled images are substantially accurate and/or precise. The calibrated system may be subsequently used to determine object depths or distances from the system (e.g., using the updated calibration parameters). The correction factor can be applied to: the image (e.g., during dewarping), the pixels (e.g., in pixel space), the calibration parameters (e.g., changing the map between the image points and the space coordinates), the space coordinates (e.g., in point space), or to any other suitable data construct. The correction factor can be applied to future images, past points or images, or any other suitable image or point determined at any suitable time. Additionally or alternatively, the correction factor can be used to physically actuate the camera position (e.g., actuate a gimbal to rotate the camera by the coplanar correction rotation; notify a user to manually adjust the camera, such as using a set screw; etc.), or be otherwise applied. The correction factor can be applied to a single camera, a single image stream, both cameras, both image streams, points extracted from a single image, points extracted from both images, point parameter values (e.g., depth information), or any other suitable construct. Applying the correction factor can include rotating the construct (e.g., image) about a correction axis by the correction factor or fraction thereof, translating the construct along the correction axis by the correction factor or fraction thereof, scaling the construct by the correction factor, or otherwise applying the correction factor. One, all, or a combination of the above recalibration methods can be applied. For example, the translational correction factor can be applied to the calibration parameters, while the coplanar correction factor is used to physically adjust the camera(s).

Different correction factors may be applied using different methods, but can alternatively be applied in the same way. In one variation, recalibrating the system using the coplanar correction factor includes rotating each image or camera by the coplanar correction factor about a non-epipolar axis, more preferably the fixed non-epipolar axis but alternatively be the variable non-epipolar axis. The images or cameras of the respective pairs may be rotated by the coplanar correction factor in opposite directions (example shown in FIG. 5), but can alternatively be rotated in the same direction or otherwise rotated. However, the coplanar correction factor can be otherwise applied. In a second variation, recalibrating the system using the translational correction factor includes rotating each image or camera by the translational correction factor about the variable non-epipolar axis, but can alternatively be rotated about the epipolar axis or any other suitable axis. The images or cameras of the respective pairs may be rotated by the translational correction factor in the same direction (example shown in FIG. 6), but can alternatively be rotated in opposite directions or otherwise rotated. However, the translational correction factor or any other suitable correction factor can be otherwise applied.

The method can optionally include initially calibrating the system, which may be used to determine an initial set of calibration parameters for image point-to-space coordinate mapping. The initial calibration can calibrate for: intrinsic distortion (e.g., through windshield, lens, other visual mediums), mechanical orientation data (e.g., translational and coplanar parameters), or any other suitable parameter. The initial calibration can be performed by the user, automatically performed (e.g., using a reference image for the system's geographic location), or otherwise performed. In a first variation, the system can be initially calibrated using a checkerboard with a known pattern. In a second variation, the system can be initially calibrated based on camera sensor measurements (e.g., using IMU/gyro measurements for rotation parameters, BLE signal strength between first and second cameras for translation parameters). In a third variation, the system can be initially calibrated using the method discussed above (e.g., using the overlap between the cameras' fields of view, which can be automatically determined using image comparison, manually determined, or otherwise determined). However, the system can be otherwise initially calibrated.

The method can optionally include calibrating auxiliary surveying systems using depth measurements from the calibrated stereocamera system, which may be used to enable in-field auxiliary surveying system calibration. Examples of auxiliary surveying systems that can be calibrated include: time-of-flight systems, LIDAR systems, photogrammetry, sheet-of-light triangulation systems, structured light systems, intreometery systems, or any other suitable system. In one variation, calibrating the auxiliary surveying system includes: identifying a set of common points (e.g., object, feature) detected by both the stereocamera system and the auxiliary surveying system, comparing the point parameters (e.g., depth, distance) measured by the auxiliary surveying system and the point parameters measured by the stereocamera system for the common points, and, when a predetermined mismatch is detected, adjusting the auxiliary surveying system calibration until the auxiliary surveying system point parameters substantially matches the stereocamera system point parameters (e.g., within a threshold error, such as 0.5%). This can optionally include notifying a user or manufacturer that the auxiliary surveying system is out of calibration or is being calibrated.

Using infinite points may be sufficient where the time-zero translational calibration is accurate. However, if the time-zero calibration is not ideal, additional information may be needed. Assume, for example, a scenario in which the time-zero calibration is not ideal and there is some translation in the ‘y’ (axis in the camera plane but normal to your chosen epipolar axis). The infinite points will still have a disparity of zero along both axes. However, as an object gets closer, there will be a disparity in both axes. Now, the disparity in the non-epipolar error axis will be very small, and only noticeable when objects get very close, but it will still be present. Therefore, the calibration system can be configured to apply an identical rotation about the ‘z’ axis (normal to the camera plane) to correct for this and better align the epipolar axis.

Because this condition cannot be detected or measured with infinite points alone, additional process steps can be included. Accordingly, in some embodiments, the calibration system evaluates points closer to the image sensor that have a large disparity and measures the disparity in the non-epipolar axis. Several of these measurements can be made and used to detect and measure the translational error. Once the translational error is determined, the system can correct for it using an inverse transformation. This process can be run independently of or in parallel with the other calibration process is described herein. However, in some embodiments, the this process can occur after the coplanar calibration correction is applied.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration. Embodiments can include every combination and permutation of the various system components and the various method processes, wherein the method processes can be performed in any suitable order, sequentially or concurrently. As a person skilled in the art will recognize from the previous detailed description and from the figures and claims, modifications and changes can be made to the embodiments of the invention without departing from the scope defined in the following claims.

What is claimed is:

1. A process for in-field camera calibration in a stereovision system, comprising:
using a plurality of cameras to capture an image pair, the image pair comprising images of a scene;
a calibration circuit identifying infinite points on the images of the image pair;
the calibration circuit determining a disparity amount between corresponding infinite points for each camera; and
the calibration circuit determining an inverse operation to reduce the determined disparity amount between the corresponding infinite points.

2. The process of claim 1, wherein identifying infinite points comprises:
tracking a point across multiple frames on a frame-by-frame basis; and
determining whether there is a frame-by-frame disparity in the tracked point above a determined threshold amount.

3. The process of claim 1, wherein identifying infinite points is performed in real time while a platform upon which the stereovision system is employed is in operation.

4. The process of claim 1, wherein the disparity between infinite points is computed and analyzed over a plurality of samples before determining the inverse.

5. The process of claim 1, wherein determining an inverse operation to reduce the determined disparity amount between the corresponding infinite points comprises determining a coplanar correction factor.

6. The process of claim 5, further comprising updating calibration parameters for one or more of the plurality of cameras based on the correction factor.

7. A process for in-field camera calibration in a stereovision system, comprising:
using a plurality of cameras to capture an image pair, the image pair comprising images of a scene;
a calibration circuit identifying corresponding points, the corresponding points comprising a point on a first image of the image pair corresponding to a point on a second image of the image pair;
the calibration circuit determining a translational disparity amount between the corresponding points for each camera; and
the calibration circuit determining an inverse operation to reduce the determined translational disparity amount between the corresponding points.

8. The process of claim 7, wherein determining a translational disparity amount between the corresponding points for each camera comprises determining a disparity in a non-epipolar coordinate, and determining the inversion operation comprises determining whether the disparity in the non-epipolar coordinate exceeds a threshold disparity amount.

9. The process of claim 7, wherein determining an inverse operation to reduce the determined translational disparity amount between the corresponding points comprises determining a translation correction factor.

10. The process of claim 9, further comprising updating calibration parameters for one or more of the plurality of cameras based on the correction factor.

11. A system for in-field camera calibration, comprising:
a plurality of cameras mounted on an operational platform;
a transmitter communicatively coupled to each of the cameras; and
a calibration circuit comprising:
a communication receiver to receive signals from the transmitters comprising image information, the communication receiver receiving an image pair, the image pair comprising images of a scene; and
a processing circuit to identify infinite points on the images of the image pair, determine a disparity amount between corresponding infinite points for each camera, and determine an inverse operation to reduce the determined disparity amount between the corresponding infinite points.
